(19) United States
(12) Patent Application Publication
(10) Pub. No.: US 2017/0123401 A1
(43) Pub. Date: May 4, 2017

(54) CONTROL METHOD AND DEVICE FOR AN INTELLIGENT EQUIPMENT

(71) Applicant: XIONG QIAN, Hangzhou City (CN)

(72) Inventor: XIONG QIAN, Hangzhou City (CN)

(21) Appl. No.: 14/980,326

(22) Filed: Dec. 28, 2015

(30) Foreign Application Priority Data
Nov. 4, 2015 (CN) 201510741338.7

(51) Int. Cl. G05B 19/19

(52) U.S. Cl. CPC G05B 19/19; G05B 2219/37494

(57) ABSTRACT

The invention provides an intelligent device control method comprising obtaining sound signal of teeth bump; based on the sound directional signal propagation time, determining one or more regions of one or more sound sources and forming a sequence of records of one or more regions; triggering a control instruction corresponding to the sound record sequence to perform intelligent control for the intelligent device. The invention also provides an intelligent device control apparatus. The technique of the invention achieves control based on the teeth bump action, without requiring the assist of the handling holding control unit, thereby applicable to the working environment with heavy hand burdens and suitable for relatively quiet and private application environment.

### TECHNICAL FIELD

The invention relates to the field of intelligent control technology, in particular to a wearable intelligent control device and control method.

### BACKGROUND

With the development of electronic information technology, intelligent devices with functionality of human computer interaction, such as all kinds of computers, smart phones and all kinds of wearable smart devices, have been widely used in various fields of social life. The control methods and control devices for this kind of intelligent equipments have been the focus of research of intelligent equipments. Intelligent equipment control technologies not only need to provide a simple way of operation, but also need to meet the requirements of special uses and special customers. Accordingly, the control technology for such an intelligent device is a key technology to affect the application and the popularization of smart devices.

The control technologies of the existing intelligent devices include the limb movement based control technologies, such as traditional keyboard, mouse, or touch screen control technologies, the body feeling control technologies and other new technologies. The drawbacks of the existing technologies are that their operation process is mainly dependent on the operator's limbs, especially hand operation. Other technologies such as voice control technologies, due to the need to make a sound, are also not suitable for the need that requires quiet and confidential working environment.

### SUMMARY

The purpose of this invention is to overcome the aforementioned shortcomings of the existing technologies for the intelligent equipment by providing a control method based on the teeth bump action of an operator. The presented control method and control device does not require hand holding control components, reducing the workload of hands, and therefore is applicable to the need that requires quiet and secure working environment.

In order to achieve above purposes, the invention uses the following technical scheme:

The invention of the intelligent device control method includes the following steps: (a) obtaining a sound signal of teeth bump; (b) based on the sound directional signal propagation time, determining one or more regions of one or more sound sources and forming a sequence of records of the one or more regions; (c) triggering a control instruction corresponding to the sound record sequence to perform intelligent control for the intelligent device.

The control method of this scheme is operated by controlling the teeth bump action of the operator, and the sound signal is obtained after the operator completes the teeth bump action. Through the sound signal directional propagation time, the sound source of the teeth bump action can be located, and a sequence of the corresponding sound source records can be produced. The record sequence records the sound source of the teeth bump and the sequence information of teeth bump, and according to the two kinds of recorded information, the control instructions are triggered.

An intelligent device control apparatus, which comprises: an acquisition module that is used to acquire the sound signal of teeth bump; a positioning module that is used to locate the sound source based on the sound directional signal propagation time and to produce a sequence of records of one or more regions of the sound source; an instruction module that is used to trigger the control instructions corresponding to the sound record sequence and to control the intelligent device in an intelligent manner.

The control scheme achieves control instructions based on the teeth bump action through the coordination of the control apparatus.

The technical scheme of the invention provides a control method that does not perform as the traditional operation mode, which requires the assist of the handling holding control unit. Therefore, it is convenient to use, efficient and accurate. The control method can also be applied to the working circumstances where the hand operation is complicated. With the assist of the control method, the more complex intelligent equipment control can be accomplished.

Therefore, the invention has the following benefits: (1) the control is achieved based on teeth bump action without requiring hand holding control unit, thereby applicable to the working environment with heavy hand burdens; (2) the control mode based on the sound source localization of the teeth bump does not produce a large noise, suitable for relatively quiet and private application environment.

### BRIEF DESCRIPTION OF DRAWINGS

FIG. 1 is a first flowchart of an intelligent device control method according to one embodiment of the present invention.

FIG. 2 is a second flowchart of an intelligent device control method according to another embodiment of the present invention.

FIG. 3 is a first schematic diagram of an intelligent device control apparatus according to one embodiment of the present invention.

FIG. 4 is a second schematic diagram of an intelligent device control apparatus according to another embodiment of the present invention.

### DETAILED DESCRIPTION

The present invention in conjunction with its accompanying drawings and specific embodiments is further described below.

The invention provides an intelligent device control method and control apparatus, which does not need to operate the same way as traditional methods using hand holding based operating unit control. Therefore, it is easy to use, fast and accurate. The invention can also be applied to working environment with complex hand operation. With the auxiliary operations of the presented control method and control apparatus, more complex intelligent device control can be achieved.

Specific embodiments of an intelligent device control method are described below:

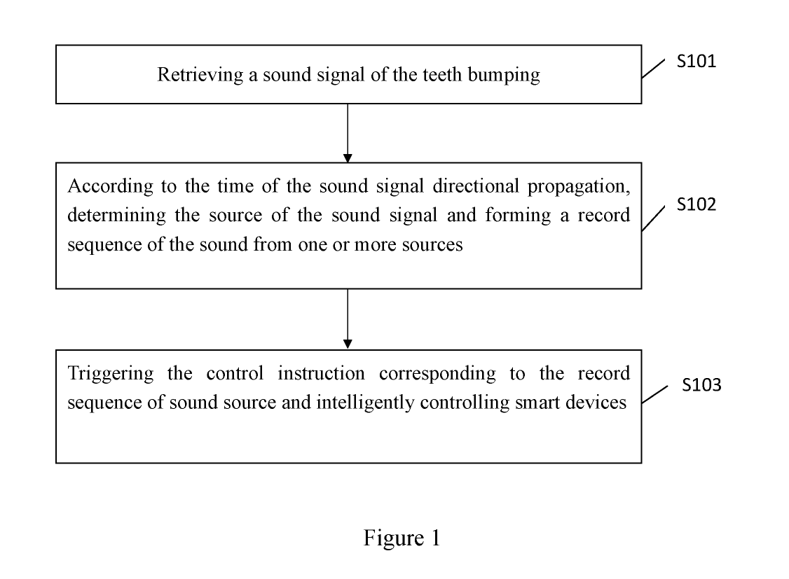

As shown in FIG. 1, illustrated is the first flowchart of an intelligent device control method according to one embodiment of the present invention. The illustrated method includes:

At step S101 the sound signal of the teeth bumping is retrieved.

The sound signal is the signal produced by upper and lower teeth bumping when the operator makes bite action, and transmitted by the operator's bone, skin, or other media. The region of the teeth bumping is determined by the active control of the operator. Through the sound signal, the teeth bumping action of the operator can be detected, and accordingly the intelligent device can be controlled.

At step S102 according to the time of the sound signal directional propagation, one or more sources of the sound signal can be determined and a record sequence of the one or more sources is formed.

Preferably, this step includes retrieval of difference of the time instants when the sound signal propagates to the two predefined test locations, and the determination of region of the source of teeth bumping sound according to the time difference and the corresponding time difference of arrival (TDOA) locating algorithm.

After acquiring the sound signal of the first teeth bumping, it is determined whether the second tooth bumping sound signal is acquired during a predefined time interval; if so, the method continues to acquire the teeth bumping sound signal, and according to the sound signal, to determine the propagation time and the region of the source of teeth bumping sound; and the method forms a record sequence using the regions of the sound sources of the first teeth bumping and the several teeth bumping continuously acquired after the first teeth bumping; if the determination is that no second tooth bumping sound signal is acquired during the predefined time interval, the source of the first teeth bumping sound is formed into the record sequence separately.

At step S103 the control instruction corresponding to the record sequence of sound source is triggered and the method intelligently controls smart devices.

The operator can control the regions of one or more teeth bumping and form identifiable information sequence, which can be remembered and reproduced by the operator. The record sequence of regions of one or more teeth bumping can be recorded and identified by programs of electronic devices. According to the preset control instruction library, the mapping between record sequences and control instructions is preset. Therefore, when the operator makes teeth bumping action, by controlling the region of the sound source of each teeth bumping, the operator can send different control instructions to smart devices and achieves the control of smart devices.

Unlike traditional operating methods, the control method of the present scheme does not require the control of hand grip operating unit. So, it is easy to use, fast and accurate. The control method can also be applied to working conditions requiring complex hand operation, and with the auxiliary operation of the present method, more complex control of smart devices can be achieved.

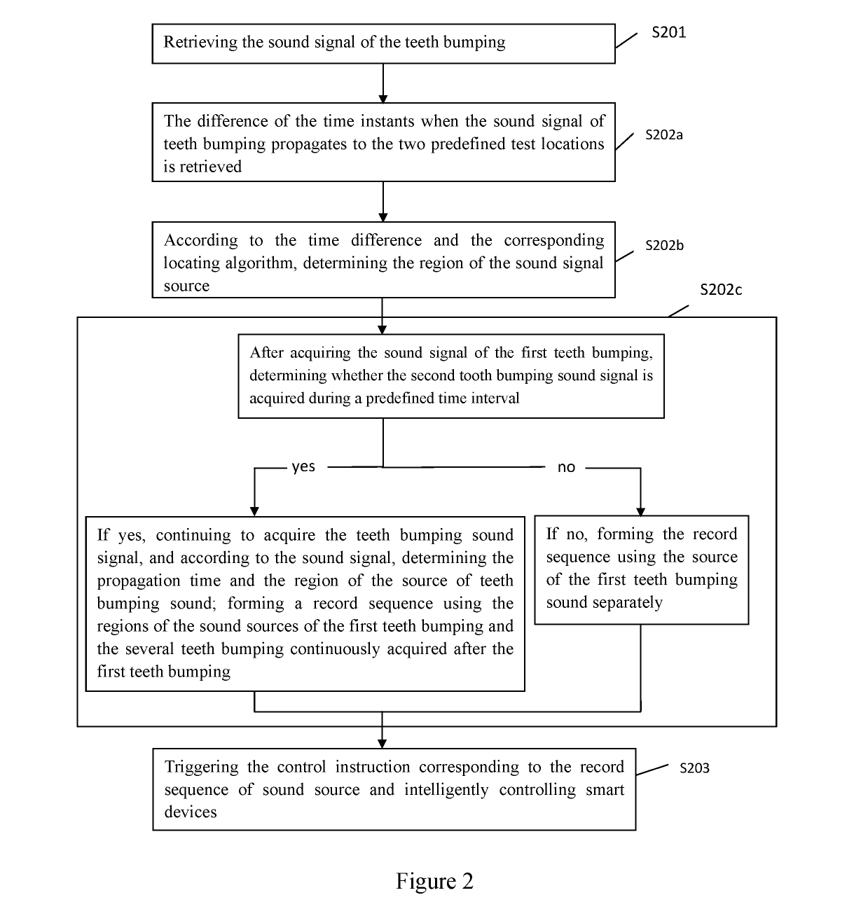

Referring to FIG. 2, illustrated is the second flow chart of the control method of smart devices according to another embodiment, which comprises:

At step S201 the sound signal of teeth bumping is retrieved.

At step S202a retrieved is the difference of the time instants when the sound signal of teeth bumping propagates to the two predefined test locations.

At step S202b according to the time difference and the corresponding TDOA locating algorithm, the region of the sound signal source is determined.

At step S202c after acquiring the sound signal of the first teeth bumping, it is determined whether the second tooth bumping sound signal is acquired during a predefined time interval; if so, the method continues to acquire the teeth bumping sound signal, and according to the sound signal, to determine the propagation time and the region of the source of teeth bumping sound; and the method forms a record sequence using the regions of the sound sources of the first teeth bumping and the several teeth bumping continuously acquired after the first teeth bumping; if the determination is that no second tooth bumping sound signal is acquired during the predefined time interval, the source of the first teeth bumping sound is formed into the record sequence separately.

S203 the control instruction corresponding to the record sequence of sound source is triggered and the method intelligently controls smart devices.

In this embodiment, the regions of teeth bumping sound source include left and right gum areas. The predefined test locations include two, which satisfy the following conditions:

The difference between the sound propagation time from the first test location to the left gum area and the sound propagation time from the first test location to the right gum area does not overlap with the difference between the sound propagation time from the second test location to the left gum area and the sound propagation time from the second test location to the right gum area.

The regions of sound sources of teeth bumping are several divided areas of the plane of the tooth edge of the bed occlusal surface of the operator. The time difference of arrival algorithm (TDOA) compares the signal arrival time for different testing locations, and produces hyperbola with the focus at testing locations and with the distance difference as its long axis. The intersection of the hyperbola is the estimated location where the sound source of teeth bumping is located. Finally, by measuring the degree of overlaps between the estimated location and pre-split regions of the sound source of teeth bumping, the final positioning of the sound source region of teeth bumping is determined.

Below is the specific embodiment. The regions of the sound source of teeth bumping can be split into the left tooth region “a” and the right gum region “b.” Retrieval module sets the testing points on both sides of the operator head, where the first test point “c” is located on the left of the operator head, and the second test point “d” is located on the right of the operator head. The propagation time from the first test point to the left gum minus the propagation time from the first test point to the right gum is denoted by [Tacmin-Tadmax, Tacmax-Tadmin] and the value of Tacmax-Tadmin is less than 0. The propagation time from the second test point to the left gum minus the propagation time from the second test point to the right gum is denoted by [Tbcmin-Tbdmax, Tbcmax-Tbdmin] and the value of Tbcmax-Tbdmin is greater than 0. When the operator makes bite action, the operator controls the left gum area of teeth bumping “a” or the right gum area of teeth bumping “b”, e.g., the left gum area of teeth bumping “a”, utilizes the time difference of sound arriving the first and the second test points to determine the region of the sound source of teeth bumping is on the left.

The controlled smart devices can be an electronic document reader, and the generated record sequence of sound source of teeth bumping includes [left], [Right], [Right, Right], [Left, Left], [Left, Right], [Right, Left], and so on. The mapping between control instructions and the record sequence of teeth bumping sound source is: [Left] corresponds to an up page sliding instruction, [Right] corresponds to a down page sliding instruction, [Left, Left] corresponds to a forward page flipping instruction, [Right, Right] corresponds to a backward page flipping instruction, [Left, Right] corresponds to a page zoom-in instruction, [Right, Left] corresponds to a page zoom-out instruction. When the operator makes teeth bumping action, the electronic document reader can be controlled to perform corresponding operations. Unlike traditional methods, the control method of the present scheme does not require the assistance of hand grip control, and therefore it is easy to use, efficient, and accurate. The method can also be applied to work conditions with complex hand operations. The control method allows us to accomplish more complex control of smart devices.

A specific embodiment of an intelligent device control apparatus is described below.

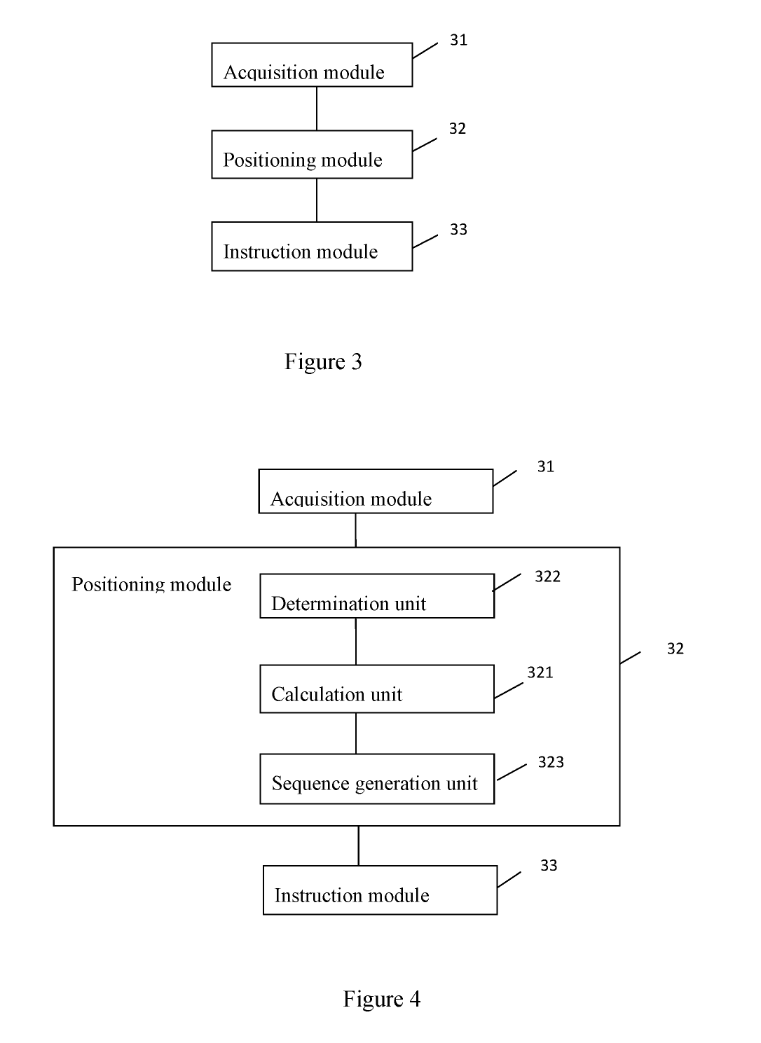

Referring now to FIG. 3, illustrated is the first flowchart of an intelligent device control apparatus according to one embodiment of the present invention, and the illustrated intelligent device control apparatus includes:

A acquisition module 31 used to retrieve the sound signal of teeth bumping;

A positioning module 32 used to determine regions of the sound source and to form one or more regions into a record sequence according to the directional propagation time of the sound signal retrieved by the retrieval module 31;

An instruction module 33 used to trigger the control commands corresponding to the record sequence generated by the positioning module 32, and thereby to control the intelligent device.

Referring to FIG. 4, illustrated is the second flowchart of an intelligent device control apparatus according to another embodiment of the present invention, where the positioning module 32 of the intelligent device control apparatus includes:

A calculation unit 321 used to retrieve the difference of times when the sound signal of teeth bumping reaches the two predefined testing points; according to the time difference and the determination algorithm of the arrival time difference, the calculation unit 321 determines the regions of sound signal of teeth bumping.

A determination unit 322 used to determine whether the sound signal of the second tooth bumping is received within the predefined time period after the sound signal of the first tooth bumping is acquired;

A sequence generation unit 323 used to perform the following operations based on the results obtained from the determination unit 322:

If the determination result is yes, then the acquisition module 31 continues to retrieve sound signal of teeth bumping, and based on the directional propagation time of sound signal of teeth bumping, the region of sound source of teeth bumping is determined; the sequence generation unit 323 forms a sound record sequence using the sound source region of the first teeth bumping and the sound source regions of several teeth bumping continuously acquired after the first teeth bumping;

If the determination result is no, the sequence generation unit 323 forms a sound record sequence of the region of sound source of the first tooth bumping separately.

The sound source regions of teeth bumping include left gum and right gum areas, and there can be two aforementioned acquisition modules 31. The position of the testing points of the acquisition modules satisfies the following conditions:

The difference between the sound propagation time from the first test location to the left gum area and the sound propagation time from the first test location to the right gum area does not overlap with the difference between the sound propagation time from the second test location to the left gum area and the sound propagation time from the second test location to the right gum area.

The acquisition module 31 of the embodiment can include Electret sensors. The positioning module 32 can include ARM processors or computer CPUs or other processors together with storage to perform its tasks. The calculation unit 321, the determination unit 322, and the sequence generation unit 323 can be programmed by computer; the instruction module 33 is achieved by wired or wireless communication module configured by control chip.

Ordinary technical staff in the related field can appreciate that all or partials procedures for implementing the method of the aforementioned embodiments can be accomplished by commanding relevant hardware with program or code. The program or code can be stored in a computer readable medium.

What is claimed is:

1. A method for controlling an intelligent device, the method comprising:
obtaining a sound signal of teeth bump;
determining one or more regions of one or more sound sources based on a sound directional signal propagation time, and forming a sequence of records of the one or more regions; and
triggering a control instruction corresponding to the record sequence to perform intelligent control for the intelligent device.

2. The method of claim 1, wherein determining one or more regions of one or more sound sources based on a sound directional signal propagation time further comprises:
retrieving a time difference of two time instants when the sound signal of teeth bump propagates to two predefined test locations; and
determining the one or more regions of the one or more sources of teeth bumping sound according to the time difference and a time difference of arrival (TDOA) locating algorithm.

3. The method of claim 1, wherein forming a sequence of records of the one or more regions further comprises:
after acquiring the sound signal of a first teeth bumping, determining whether a second tooth bumping sound signal is acquired during a predefined time interval;
if it is determined that the second tooth bumping sound signal has been acquired during a predefined time interval;
continuously acquiring the teeth bumping sound signals, and determine the one or more regions of the one or more sound sources of teeth bumping sound according to the sound signal directional propagation time; and
forming the sequence of records using the region of the sound source of the first teeth bumping and the multiple regions of sounds sources of the teeth bumping continuously acquired after the first teeth bumping;
if it is determined that no second tooth bumping sound signal has been acquired during a predefined time interval;
forming the sequence of records using the region of the sound source of the first teeth bumping sound alone.

4. The method of claim 2, wherein forming a sequence of records of the one or more regions further comprises:
after acquiring the sound signal of a first teeth bumping, determining whether a second tooth bumping sound signal is acquired during a predefined time interval;
if it is determined that the second tooth bumping sound signal has been acquired during a predefined time interval;
continuously acquiring the teeth bumping sound signals, and determine the one or more regions of the one or more sound sources of teeth bumping sound according to the sound signal directional propagation time; and
forming the sequence of records using the region of the sound source of the first teeth bumping and the multiple regions of sounds sources of the teeth bumping continuously acquired after the first teeth bumping;
if it is determined that no second tooth bumping sound signal has been acquired during a predefined time interval;
forming the sequence of records using the region of the sound source of the first teeth bumping sound alone.

5. The method of claim 2, wherein the one or more regions of sound sources comprises left and right gum areas and wherein the two predefined test locations satisfy that the difference between the sound propagation time from the first test location to the left gum area and the sound propagation time from the first test location to the right gum area does not overlap with the difference between the sound propagation time from the second test location to the left gum area and the sound propagation time from the second test location to the right gum area.

6. An intelligent device control apparatus, the apparatus comprising:
a processor; and
a non-transitory computer readable medium storing instructions, executable by the processor for controlling the intelligent device, the instructions comprising:
an acquisition module for obtaining a sound signal of teeth bump;
a positioning module for determining one or more regions of one or more sound sources based on a sound directional signal propagation time and forming a sequence of records of the one or more regions; and
an instruction module for triggering a control instruction corresponding to the record sequence to perform intelligent control for the intelligent device.

7. The apparatus of claim 6, wherein the positioning module further comprises:
a calculation unit for retrieving a time difference of two time instants when the sound signal of teeth bump propagates to two predefined test locations and determining the one or more regions of the one or more sources of teeth bumping sound according to the time difference and a time difference of arrival (TDOA) locating algorithm.

8. The apparatus of claim 6, wherein the positioning module further comprises:
a determination unit for determining whether a second tooth bumping sound signal is acquired during a predefined time interval after acquiring the sound signal of a first teeth bumping; and
a sequence generation unit for performing the following operations based on the result of determination:
if it is determined that the second tooth bumping sound signal has been acquired during a predefined time interval;
continuously acquiring the teeth bumping sound signals, and determine the one or more regions of the one or more sound sources of teeth bumping sound according to the sound signal directional propagation time; and
forming the sequence of records using the region of the sound source of the first teeth bumping and the multiple regions of sounds sources of the teeth bumping continuously acquired after the first teeth bumping; and
if it is determined that no second tooth bumping sound signal has been acquired during a predefined time interval;
forming the sequence of records using the region of the sound source of the first teeth bumping sound alone.

9. The apparatus of claim 6, wherein the one or more regions of sound sources comprises left and right gum areas, and the apparatus comprises two acquisition modules, wherein the two predefined test locations set by the two acquisition modules satisfy that the difference between the sound propagation time from the first test location to the left gum area and the sound propagation time from the first test location to the right gum area does not overlap with the difference between the sound propagation time from the second test location to the left gum area and the sound propagation time from the second test location to the right gum area.
